(19) United States
(12) Patent Application Publication
(10) Pub. No.: US 2025/0255347 A1
(43) Pub. Date: Aug. 14, 2025

(54) AEROSOL-GENERATING DEVICE AND MICROWAVE HEATING ASSEMBLY THEREOF

(71) Applicant: SMOORE INTERNATIONAL HOLDINGS LIMITED, George Town (KY)

(72) Inventors: Jing DU, Shenzhen (CN); Yang DENG, Shenzhen (CN); Yonghai LAN, Shenzhen (CN); Dongjian LI, Shenzhen (CN); Guihua BU, Shenzhen (CN); Feng LIANG, Shenzhen (CN)

(21) Appl. No.: 19/195,351

(22) Filed: Apr. 30, 2025

Related U.S. Application Data
(63) Continuation of application No. PCT/CN2022/129368, filed on Nov. 2, 2022.

(51) Int. Cl. A24F 40/46; H05B 6/66; H05B 6/80

(52) U.S. Cl. CPC A24F 40/46; H05B 6/66; H05B 6/802

(57) ABSTRACT

A microwave heating assembly for an aerosol-generating device includes: an outer conductor unit in a cylindrical shape and including an open end, a closed end opposite the open end, and a cavity located between the open end and the closed end; an inner conductor unit arranged in the cavity, one end of the inner conductor being connected to an end wall of the closed end, and an other end of the inner conductor unit extending toward the open end; and a microwave feed unit including: an outer conductor mounted on the outer conductor unit and in ohmic contact with the outer conductor unit, and an inner conductor arranged in the outer conductor and including a feed end extending into the cavity so as to feed microwaves. An insertion hole is provided on an inner side of the outer conductor unit or on the inner conductor unit.

### CROSS-REFERENCE TO PRIOR APPLICATION

This application is a continuation of International Patent Application No. PCT/CN2022/129368, filed on Nov. 2, 2022. The entire disclosure is hereby incorporated by reference herein.

### FIELD

The present invention relates to the field of electronic atomization, and in particular, to an aerosol-generating device and a microwave heating assembly thereof.

### BACKGROUND

In the related art, a microwave-heating aerosol-generating device includes a microwave heating assembly, and the microwave heating assembly includes an outer conductor unit, an inner conductor unit, and a microwave feed unit. The microwave feed unit functions to conduct microwaves. A feed end of the inner conductor of the microwave feed unit extends into the outer conductor unit and is in ohmic contact with the side wall of the inner conductor unit, to satisfy a microwave feed requirement.

However, during heating of the microwave heating assembly, as the temperature increases, thermal expansion and contraction occur in the outer conductor unit, the inner conductor unit, and the inner conductor, which is likely to lead to the formation of a gap between the inner conductor and the inner conductor unit and/or the outer conductor unit. As a result, microwaves cannot be effectively fed into the inner conductor unit. In addition, during mechanical processing, there is a tolerance range (usually with a size deviation ranging from 0.01 mm to 0.05 mm) for the inner conductor, the inner conductor unit, and the outer conductor unit, which is likely to lead to the formation of a gap between the inner conductor and the inner conductor unit and/or the outer conductor unit. Consequently, there is a risk of poor contact, which is also likely to lead to failure of microwave feed.

### SUMMARY

In an embodiment, the present invention provides a microwave heating assembly for an aerosol-generating device, the microwave heating assembly comprising: an outer conductor unit in a cylindrical shape and comprising an open end, a closed end opposite the open end, and a cavity located between the open end and the closed end; an inner conductor unit arranged in the cavity, one end of the inner conductor being connected to an end wall of the closed end, and an other end of the inner conductor unit extending toward the open end; and a microwave feed unit, comprising: an outer conductor mounted on the outer conductor unit and in ohmic contact with the outer conductor unit, and an inner conductor arranged in the outer conductor and comprising a feed end extending into the cavity so as to feed microwaves, wherein an insertion hole is provided on an inner side of the outer conductor unit or on the inner conductor unit, the feed end extending into the insertion hole.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic diagram of an external structure of a microwave heating assembly according to Embodiment 1 of the present invention;

FIG. 2 is a longitudinal structural cross-sectional view of the microwave heating assembly shown in FIG. 1;

FIG. 3 is a structural enlarged view in which a gap exists between the outer wall surface of an inner conductor and the inner wall surface of an insertion hole according to Embodiment 1 of the present invention;

FIG. 4 is a structural enlarged view in which a gap exists between the outer peripheral wall surface of the inner conductor and the inner peripheral wall surface of the insertion hole according to Embodiment 1 of the present invention;

FIG. 5 is a longitudinal structural cross-sectional view of a microwave heating assembly according to Embodiment 2 of the present invention;

FIG. 6 is a structural enlarged view in which an inner conductor is in complete contact with the inner wall surface of an insertion hole according to Embodiment 2 of the present invention;

FIG. 7 is a structural enlarged view in which a gap exists between a feed end of the inner conductor and the bottom of the insertion hole according to Embodiment 2 of the present invention;

FIG. 8 is a longitudinal structural cross-sectional view of a microwave heating assembly according to Embodiment 3 of the present invention;

FIG. 9 is a structural enlarged view in which a gap exists between the outer wall surface of a third inner conductor and the inner wall surface of a third insertion hole according to Embodiment 3 of the present invention;

FIG. 10 is a longitudinal structural cross-sectional view of a microwave heating assembly according to Embodiment 4 of the present invention;

FIG. 11 is a structural enlarged view in which an inner conductor is inserted into an insertion hole located on a conductor end wall of an outer conductor unit according to Embodiment 4 of the present invention;

FIG. 12 is a longitudinal structural cross-sectional view of a microwave heating assembly according to Embodiment 5 of the present invention;

FIG. 13 is a structural enlarged view in which an inner conductor is inserted into an insertion hole provided on a boss of an outer conductor unit according to Embodiment 5 of the present invention;

FIG. 14 is a longitudinal structural cross-sectional view of a microwave heating assembly according to Embodiment 6 of the present invention;

FIG. 15 is a structural enlarged view in which an inner conductor is inserted into an insertion hole located on a conductor side wall of an outer conductor unit according to Embodiment 6 of the present invention;

FIG. 16 is a scattering parameter diagram obtained by testing in Experiment 1 based on the microwave heating assembly according to Embodiment 1 of the present invention;

FIG. 17 is a scattering parameter diagram obtained by testing in Experiment 2 based on the microwave heating assembly according to Embodiment 1 of the present invention;

FIG. 18 is a scattering parameter diagram obtained by testing in Experiment 3 based on the microwave heating assembly according to Embodiment 1 of the present invention;

FIG. 19 is a scattering parameter diagram obtained by testing in Experiment 4 based on the microwave heating assembly according to Embodiment 1 of the present invention;

FIG. 20 is a scattering parameter diagram obtained by testing in Experiment 5 based on the microwave heating assembly according to Embodiment 1 of the present invention;

FIG. 21 is a scattering parameter diagram obtained by testing in Experiment 6 based on the microwave heating assembly according to Embodiment 1 of the present invention;

FIG. 22 is a scattering parameter diagram obtained by testing in Experiment 7 based on the microwave heating assembly according to Embodiment 1 of the present invention;

FIG. 23 is a scattering parameter diagram obtained by testing in Experiment 8 based on the microwave heating assembly according to Embodiment 1 of the present invention;

FIG. 24 is a scattering parameter diagram obtained by testing in Experiment 9 based on the microwave heating assembly according to Embodiment 1 of the present invention;

FIG. 25 is a scattering parameter diagram obtained by testing in Experiment 10 based on the microwave heating assembly according to Embodiment 1 of the present invention;

FIG. 26 is a scattering parameter diagram obtained by testing in Experiment 11 based on the microwave heating assembly according to Embodiment 1 of the present invention;

FIG. 27 is a scattering parameter diagram obtained by testing in Experiment 12 based on the microwave heating assembly according to Embodiment 1 of the present invention;

FIG. 28 is a scattering parameter diagram obtained by testing in Experiment 13 based on a second microwave heating assembly according to Embodiment 2 of the present invention; and

FIG. 29 is a scattering parameter diagram obtained by testing in Experiment 14 based on the second microwave heating assembly according to Embodiment 2 of the present invention.

### DETAILED DESCRIPTION

In an embodiment, the present invention provides an improved aerosol-generating device and a microwave heating assembly thereof.

In an embodiment, the present invention constructs a microwave heating assembly, used in an aerosol-generating device, including:
an outer conductor unit, configured in a cylindrical shape and including an open end, a closed end opposite to the open end, and a cavity located between the open end and the closed end;
an inner conductor unit, arranged in the cavity, where one end of the inner conductor unit is connected to the end wall of the closed end, and the other end of the inner conductor unit extends toward the open end; and
a microwave feed unit, including:
an outer conductor, mounted on the outer conductor unit and in ohmic contact with the outer conductor unit;
and
an inner conductor, arranged in the outer conductor, and including a feed end extending into the cavity to feed microwaves, where
an insertion hole is provided on the inner side of the outer conductor unit or on the inner conductor unit, and the feed end extends into the insertion hole.

In some embodiments, the feed end is in ohmic contact with the inner wall surface of the insertion hole.

In some embodiments, a first gap exists between the end surface of the feed end and the bottom of the insertion hole, and the first gap is less than or equal to 0.1 mm; and
a second gap exists between the outer peripheral wall surface of the feed end and the inner peripheral wall surface of the insertion hole, and the second gap is less than or equal to 0.1 mm.

In some embodiments, the insertion hole is a blind hole.

In some embodiments, the depth of the insertion hole ranges from 0.9 mm to 2.6 mm.

In some embodiments, the insertion hole is cylindrical, and the diameter of the insertion hole ranges from 0.65 mm to 0.9 mm.

In some embodiments, a feed hole that communicates with the cavity and the outside is provided on the side wall of the outer conductor unit, and the outer conductor is embedded in the feed hole.

In some embodiments, the inner conductor unit is coaxial with the outer conductor unit.

In some embodiments, the inner conductor unit includes a conductor column, and the conductor column includes a fixed end and a free end; the fixed end is connected to the closed end and is in ohmic contact with the end wall of the closed end; and the free end extends toward the open end.

In some embodiments, the insertion hole is provided on the outer peripheral wall of the conductor column and is opposite to the feed hole, and the insertion hole extends in the radial direction of the conductor column.

In some embodiments, the inner conductor unit further includes a boss fitted to the side wall of the conductor column, where the boss protrudes from the conductor column toward the feed hole; and the insertion hole is formed in the boss and extends away from the feed hole and along the end surface of the boss facing the feed hole.

In some embodiments, the bottom of the insertion hole extends into the conductor column.

In some embodiments, the inner conductor is in the shape of a straight line and extends into the insertion hole in the direction perpendicular to the axis of the conductor column.

In some embodiments, the insertion hole is formed on the end wall of the closed end.

In some embodiments, a boss protruding toward the open end is provided on the end wall of the closed end, and the insertion hole is provided on the boss.

In some embodiments, the inner conductor is L-shaped and includes a first segment and a second segment connected to the first segment, where
the end of the first segment away from the second segment is configured to receive microwaves, and the end of the second segment away from the first segment is the feed end.

In some embodiments, the insertion hole is provided on the inner peripheral side wall of the outer conductor unit.

In some embodiments, a boss protruding outward is further arranged on the outer surface of the outer conductor unit; and the insertion hole runs through the wall surface of the outer conductor unit and extends toward the boss, an opening of the insertion hole is formed on the inner wall surface of the outer conductor unit, and the bottom of the insertion hole extends into the boss.

In some embodiments, the inner conductor is U-shaped and includes a first segment, a second segment, and a third segment; the third segment is parallel to the first segment, and two ends of the second segment are respectively connected to the first segment and the third segment; and the end of the first segment away from the second segment is configured to receive microwaves, and the end of the third segment away from the second segment is the feed end.

In some embodiments, the inner conductor unit further includes a conductor disk, the conductor disk is axially fitted to the free end, the diameter of the conductor disk is greater than the diameter of the conductor column, and a spacing is set between the conductor disk and the inner wall surface of the outer conductor unit.

In some embodiments, the inner conductor unit further includes a probe apparatus having an elongated shape, and an end of the probe apparatus is inserted into the conductor disk and is in ohmic contact with the conductor disk.

In some embodiments, the microwave heating assembly further includes an accommodating base mounted on the open end, the accommodating base includes an accommodating portion configured to accommodate an aerosol-generation substrate, and the accommodating portion is located in the cavity.

In the present invention, an aerosol-generating device is further constructed, including a microwave-generating device, and further including the microwave heating assembly. The microwave feed unit is connected to the microwave-generating device.

### Beneficial Effects

Implementation of the present invention has the following beneficial effect: In the present invention, an insertion hole is provided on an inner conductor unit or the inner side of an outer conductor unit for inserting a feed end of an inner conductor of a microwave feed unit, thereby improving reliability of microwave feeding.

List of Reference Numerals: microwave heating assembly 100; microwave feed unit 2; outer conductor unit 11; inner conductor unit 12; accommodating base 13; closed end 111; open end 112; heating area 113; conductor side wall 114; conductor end wall 115; feed hole 116; conductor column 121; conductor disk 122; probe apparatus 123; insertion hole 14; accommodating portion 131; fixing portion 132; positioning rib 133; accommodating cavity 1311; through hole 1321; outer conductor 21; inner conductor 22; dielectric layer 23; connecting end 221; feed end 222; first gap 241; second gap 242;
second microwave heating assembly 100a; second microwave feed unit 2a; second inner conductor unit 12a; second conductor column 121a; second conductor disk 122a; second probe apparatus 123a; second insertion hole 14a; second boss 15a; second outer conductor 21a; second inner conductor 22a; second dielectric layer 23a;
third microwave heating assembly 100b; third microwave feed unit 2b; third inner conductor unit 12b; third conductor column 121b; third conductor disk 122b; third probe apparatus 123b; third insertion hole 14b; third boss 15b; third outer conductor 21b; third inner conductor 22b; third dielectric layer 23b;
fourth microwave heating assembly 100c; fourth microwave feed unit 2c; fourth outer conductor unit 11c; fourth inner conductor unit 12c; fourth accommodating base 13c; fourth closed end 111c; fourth open end 112c; fourth conductor side wall 114c; fourth conductor end wall 115c; fourth feed hole 116c; fourth insertion hole 14c; fourth conductor column 121c; fourth conductor disk 122c; fourth probe apparatus 123c; fourth outer conductor 21c; fourth inner conductor 22c; fourth dielectric layer 23c; first segment 223c; second segment 224c;

fifth microwave heating assembly 100d; fifth microwave feed unit 2d; fifth outer conductor unit 11d; fifth closed end 111d; fifth open end 112d; fifth conductor side wall 114d; fifth conductor end wall 115d; fifth feed hole 116d; fifth insertion hole 14d; fifth boss 15d; fifth outer conductor 21d; fifth inner conductor 22d; fifth dielectric layer 23d; first segment 223d; second segment 224d;

sixth microwave heating assembly 100e; sixth outer conductor unit 11e; sixth microwave feed unit 2e; sixth closed end 111e; sixth open end 112e; six conductor side wall 114e; sixth conductor end wall 115e; sixth feed hole 116e; sixth insertion hole 14c; sixth boss 15e; sixth outer conductor 21e; sixth inner conductor 22e; sixth dielectric layer 23e; first segment 223e; second segment 224e; and second segment 225e.

To provide a clearer understanding of the technical features, objectives, and effects of the present invention, specific implementations of the present invention are described in detail with reference to the accompanying drawings. In the following descriptions of this application, it should be understood that orientation or position relationships indicated by the terms such as “front”, “rear”, “on”, “below”, “left”, “right”, “longitudinal”, “latitudinal”, “vertical”, “horizontal”, “top”, “bottom”, “inside”, “outside”, “head”, and “tail” are based on orientation or position relationships shown in the accompanying drawings, are used only for case of describing the technical solution, rather than indicating that the apparatus or clement must have a particular orientation or be constructed and operated in a particular orientation. Therefore, such terms should not be construed as a limitation to the present invention.

It should be further noted that unless otherwise explicitly specified and defined, terms such as “mounted”, “connected”, “connection”, “fixed”, and “arranged” should be understood in a broad sense. For example, a connection may be a fixed connection, a detachable connection, or an integral connection; the connection may be a mechanical connection or an electrical connection; or the connection may be a direct connection, an indirect connection through an intermediate medium, internal communication between two elements, or an interaction relationship between two elements. When an element is being “above” or “below” another element, the element can be “directly” or “indirectly” located above the another element, or one or more intermediate elements may exist. The terms such as “first”, “second”, and “third” are merely intended for case of describing of the technical solution, and shall not be understood as indicating or implying relative significance or implicitly indicating the number of indicated technical features. Therefore, a feature defined by the terms such as “first”, “second”, and “third” may explicitly or implicitly include one or more of the features. A person of ordinary skill in the art may understand the specific meanings of the foregoing terms in the present invention according to specific situations.

In the following descriptions, for the purpose of description rather than limitation, specific details such as specific system structures, and technologies are proposed to thoroughly understand the embodiments of the present invention. However, it should be clear to a person skilled in the art that the present invention may also be implemented in other embodiments without these specific details. In other cases, detailed descriptions of well-known systems, apparatuses, circuits, and methods are omitted, so that the present invention is described without being obscured by unnecessary details.

According to the present invention, an aerosol-generating device is constructed. The aerosol-generating device can heat an aerosol-forming article by using microwaves for atomization to generate an aerosol, for a user to inhale. In some embodiments, the aerosol-forming article is a solid aerosol-forming article such as a processed plant leaf product. It may be understood that, in some other embodiments, the aerosol-forming article may be a liquid aerosol-forming article.

The aerosol-generating device may include a microwave-generating device and a microwave heating assembly 100. The microwave-generating device can generate microwaves. The microwave heating assembly 100 is connected to the microwave-generating device to receive the microwaves, and forms a microwave field in a cavity of the microwave heating assembly 100. The microwave field can act on the aerosol-forming article to implement microwave heating on the aerosol-forming article.

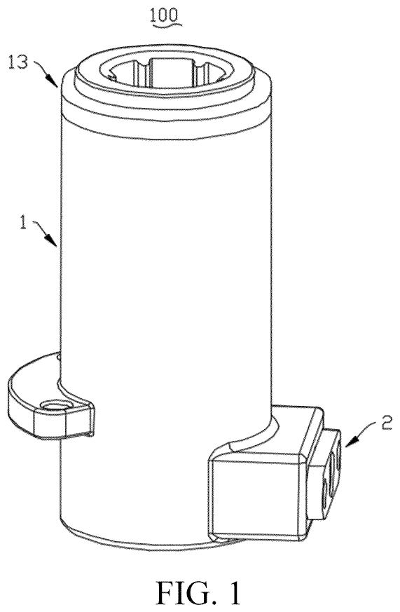

Referring to FIG. 1, the appearance of the microwave heating assembly 100 is approximately in the shape of a circular column. Certainly, the microwave heating assembly 100 is not limited to being in the shape of the circular column, and may alternatively be in other shapes such as a rectangular column or an elliptical column.

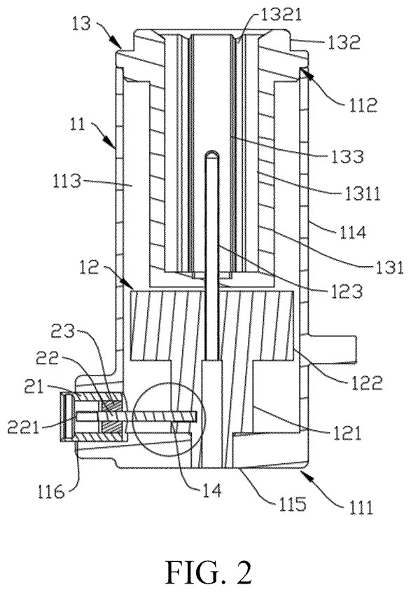

Referring to FIG. 2, the microwave heating assembly 100 may include an outer conductor unit 11, an inner conductor unit 12, an accommodating base 13, and a microwave feed unit 2. The outer conductor unit 11 is configured in a cylindrical shape, include a closed end 111 and an open end 112 opposite to the closed end 111, and can define a semi-closed cavity. The cavity is in the shape of a circular column. The inner conductor unit 12 is configured to adjust a resonance frequency and microwave distribution in the cavity. The inner conductor unit 12 is coaxially arranged in the cavity of the outer conductor unit 11, one end of the inner conductor unit 12 is connected to the closed end 111 of the outer conductor unit 11 and is in ohmic contact with the end wall of the closed end 111, to form a short-circuit end of the microwave heating assembly 100; and the other end of the inner conductor unit 12 extends toward the open end 112 of the outer conductor unit 11 and is not in contact with the outer conductor unit 11, to form an open-circuit end of the microwave heating assembly 100. The accommodating base 13 is configured to load an aerosol-forming article, and is fixedly or detachably mounted at the open end 112 of the outer conductor unit 11. When being inserted into the accommodating base 13, the aerosol-forming article may be located at a position at which the microwave field is formed. The microwave feed unit 2 is configured to feed the microwaves generated by the microwave-generating device into the cavity (where a feeding manner may include an electric feeding manner or a magnetic feeding manner; and the electric feeding manner is preferred). The microwave feed unit 2 is detachably mounted on the outer peripheral wall of the outer conductor unit 11.

Referring to FIG. 2, in this embodiment, the outer conductor unit 11 may include a conductor side wall 114 and a conductor end wall 115 that are conductive. The conductor side wall 114 may be cylindrical and includes two ends that are oppositely arranged. The conductor end wall 115 is closed at a first end of the conductor side wall 114, to form the closed end 111. A second end of the conductor side wall 114 has an open structure, to form the open end 112 for the accommodating base 13 to be mounted therein. In addition, a feed hole 116 radially running through is provided at a position close to the conductor end wall 115 of the conductor side wall 114. The feed hole 116 can be used for inserting the microwave feed unit 2 into the outer conductor unit 11. The hole size of the feed hole 116 matches the outer diameter of the outer conductor 21 of the microwave feed unit 2.

In this embodiment, the inner conductor unit 12 may include a conductor column 121, a conductor disk 122 located above the conductor column 121, and a probe apparatus 123 embedded in the conductor disk 122.

The conductor column 121 may be in the shape of a circular column, the end (namely, the bottom end) of the conductor column 121 away from the open end 112 of the outer conductor unit 11 is coaxially connected to the conductor end wall 115 of the outer conductor unit 11, and the end (namely, the top end) of the conductor column 121 close to the open end 112 extends toward the open end 112 of the outer conductor unit 11. The diameter of the conductor column 121 is less than the inner diameter of the outer conductor unit 11. It may be understood that the conductor column 121 is not limited to the shape of the circular column, and may alternatively be in other shapes such as a rectangular column, an elliptical column, a stepped column, and an irregular column.

An insertion hole 14 is provided on the outer peripheral side of the conductor column 121 opposite to the feed hole 116 of the outer conductor unit 11. The insertion hole 14 is configured for inserting the inner conductor 22 of the microwave feed unit 2, to reduce a risk of poor contact between the inner conductor 22 and the conductor column 121. In this embodiment, the insertion hole 14 is a blind hole, which is a straight columnar channel, and extends toward the inside of the conductor column 121 along the outer peripheral side surface of the conductor column 121 opposite to the feed hole 116 of the outer conductor unit 11.

Optionally, the depth of the insertion hole ranges from 0.9 mm to 2.6 mm. Optionally, the diameter of the insertion hole ranges from 0.65 mm to 0.9 mm.

The conductor disk 122 is configured to conduct microwaves, and may further increase inductance and capacitance of the conductor disk, and reduce a resonance frequency, so that the size of the cavity can be further reduced. The conductor disk 122 may be in the shape of a disk, the diameter of the conductor disk is greater than the diameter of the conductor column 121, and is coaxially arranged on the top end (namely, a free end) of the conductor column 121. The conductor disk 122 may be integrally fitted to the conductor column 121, or may be in ohmic contact with the conductor column 121. It may be understood that, the conductor disk 122 is not a necessary part of the microwave heating assembly 100, and is applied to this embodiment as a preferred solution. When no conductor disk 122 is provided, microwave heating may also be implemented by depending on the conductor column 121 and the probe apparatus 123.

The probe apparatus 123 is configured to adjust microwave field distribution and a microwave feed frequency, and used as an independent structure (in other words, the probe apparatus 123 is detachably connected to the conductor disk 122 and the conductor column 121), may be extracted from the top end of the conductor disk 122/inserted into the conductor disk 122, and form ohmic contact with the conductor disk 122. In this embodiment, the probe apparatus 123 may include an elongated probe; the lower end of the probe is inserted from the top end of the conductor column 121, and is coaxially embedded in the conductor disk 122, to form good ohmic contact with the conductor disk 122; and the upper end of the probe extends upward into the accommodating base 13. It may be understood that when microwaves are fed into the microwave heating assembly 100, a microwave field is formed around a partial structure of the probe apparatus 123 that extends into the accommodating base 13. When the aerosol-forming article extends into the accommodating base 13 and is inserted into the upper end of the probe, microwave heating can be performed on the aerosol-forming article.

Optionally, a shape of the upper end portion of the probe may include one of a plane, a sphere, an ellipsoid, a cone, or a truncated cone. The truncated cone is preferred because the truncated cone can enhance a local field strength, thereby increasing an atomization speed of the aerosol-forming material.

As shown in FIG. 2, the accommodating base 13 in this embodiment may include an accommodating portion 131 and a fixing portion 132 integrally connected to the accommodating portion 131. The accommodating portion 131 is configured to accommodate the aerosol-forming article. The fixing portion 132 is configured to axially block the open end 112 of the outer conductor unit 11, and allow the accommodating portion 131 to extend into the heat area 113, so that the probe apparatus 123 passes through in the accommodating portion 131.

In this embodiment, the accommodating portion 131 may be cylindrical, and the outer diameter of the accommodating portion 131 may be less than the inner diameter of the outer conductor unit 11. The accommodating portion 131 includes an axial accommodating cavity 1311 configured to accommodate the aerosol-forming article. The fixing portion 132 may be annular and is coaxially connected to the accommodating portion 131. The fixing portion 132 may be coaxially block the open end 112 of the outer conductor unit 11, so that the accommodating portion 131 is coaxially arranged in the heat area 113. The fixing portion 132 includes an axial through hole 1321 connecting the accommodating cavity 1311 to the external environment, and the aerosol-generating article can be inserted into the accommodating cavity 1311 through the through hole 1321.

In this embodiment, the accommodating base 13 further includes several elongated positioning ribs 133. These positioning ribs 133 are uniformly spaced circumferentially on the wall surfaces of the accommodating cavity 1311 and/or the through hole 1321. Each positioning rib 133 extends in the direction parallel to the axis of the accommodating base 13. The positioning ribs 133 may be configured to clamp the aerosol-forming article inserted into the accommodating cavity 1311 and/or the through hole 1321. In addition, an air inlet channel longitudinal extending is formed between every two adjacent positioning ribs 133, so that air in the environment is conveniently drawn to the bottom of the aerosol-forming article, and then enters the aerosol- forming article, to carry the aerosol of the aerosol-forming article that is generated through microwave heating.

As shown in FIG. 2 to FIG. 4, the microwave feed unit 2 may be a coaxial connector in this embodiment, is inserted from the feed hole 116 located on the peripheral side of the outer conductor unit 11, and is mounted on the outer conductor unit 11. The microwave feed unit 2 includes an outer conductor 21, an inner conductor 22 arranged in the outer conductor 21, and a dielectric layer 23 between the inner conductor 22 and the outer conductor 21.

In this embodiment, the outer conductor 21 has a straight cylindrical structure with an opening structure at two ends; and when the microwave feed unit 2 is mounted on the outer conductor unit 11, the side wall of the outer conductor 21 is in ohmic contact with the inner wall surface of the feed hole 116 located on the outer conductor unit 11.

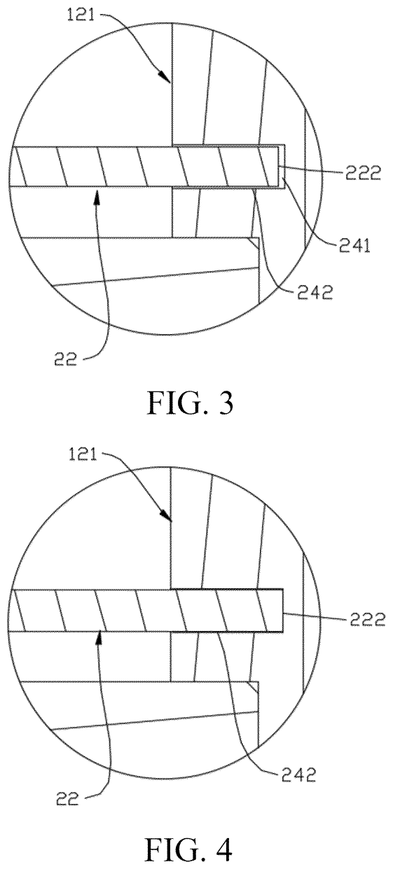

The inner conductor 22 has a straight-line, needle-like structure and is in the shape of a straight circular column. Optionally, the diameter of the inner conductor 22 ranges from 0.55 mm to 0.8 mm. The inner conductor 22 includes two opposite ends, and one end is a connecting end 221 and located in the outer conductor 21; and the other end is a feed end 222 and located outside the outer conductor 21. The connecting end 221 is configured to be connected to the microwave-generating device, to receive the microwaves. A connection manner may be a coaxial connection manner or a microstrip line connection manner. The feed end 222 is relatively close to the inner conductor unit 12 when the microwave feed unit 2 is mounted on the outer conductor unit 11, and is configured to be inserted into the insertion hole 14 of the conductor column 121 to implement electric coupling or magnetic coupling, to guide the microwaves to the inner conductor unit 12. It may be understood that, in the present invention, by providing the insertion hole 14 on the conductor column 121 of the inner conductor unit 12 to cooperate with the inner conductor 22 of the microwave feed unit 2, after the inner conductor 22 extends into the insertion hole 14, a gap may exist between the outer wall surface of the inner conductor 22 and the inner wall surface of the insertion hole 14 due to processing precision, thermal expansion and contraction, or the like. As shown in FIG. 3, the gap includes a first gap 241 formed between the feed end 222 of the inner conductor 22 and the bottom of the insertion hole 14 and a second gap 242 formed between the outer peripheral wall surface of the inner conductor 22 and the inner peripheral wall surface of the insertion hole 14. As shown in FIG. 4, the second gap 242 is formed between the inner conductor 22 and the insertion hole 14.

However, provided that the gap is less than a specific range (less than or equal to 0.1 mm), effective feeding of the microwaves can also be implemented even if the inner conductor 22 is not in direct contact with the conductor column 121. It may also be understood that, provided that the first gap 241 and/or the second gap 242 are separately less than or equal to 0.1 mm, good microwave feed can be implemented. In this case, the feeding manner is capacitive feeding. The feeding manner requires a simple structure, and can ensure effective feeding of microwaves.

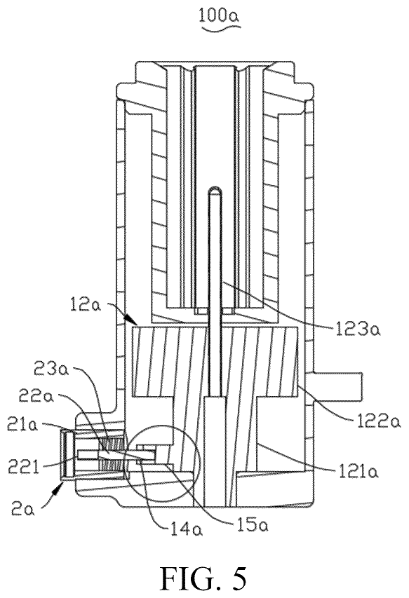

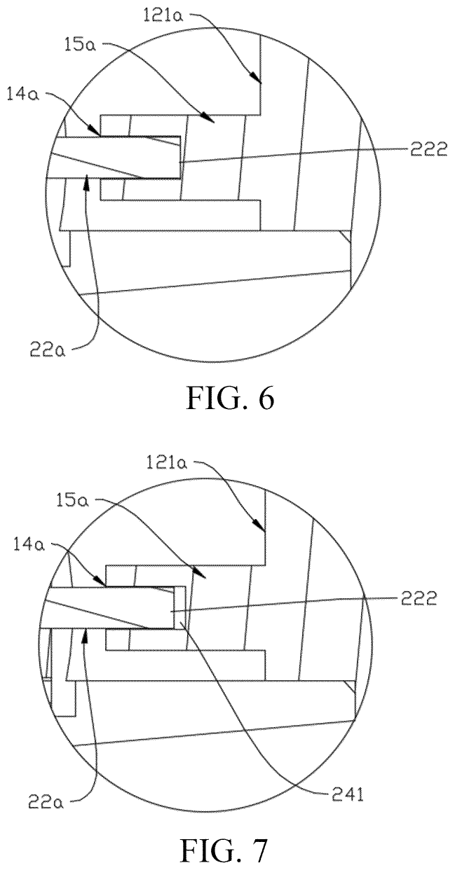

FIG. 5 and FIG. 6 show a second microwave heating assembly 100a according to Embodiment 2 of the present invention. A difference between this embodiment and Embodiment 1 lies in: The inner conductor unit 12 and the microwave feed unit 2 are respectively replaced with a second inner conductor unit 12a and a second microwave feed unit 2a.

As shown in FIG. 5, in this embodiment, the second inner conductor unit 12a includes a second conductor column 121a, a second conductor disk 122a located above the second conductor column 121a, a second boss 15a arranged on the outer peripheral side surface of the second conductor column 121a, and a second probe apparatus 123a embedded in the second conductor disk 122a.

The second conductor column 121a is in the shape of a circular column, the end (namely, the bottom end) of the conductor column 121a away from the open end 112 of the outer conductor unit 11 is coaxially connected to the conductor end wall 115 of the outer conductor unit 11, and the end (namely, the top end) of the conductor column 121a close to the open end 112 extends toward the open end 112 of the outer conductor unit 11. The diameter of the second conductor column 121a is less than the inner diameter of the outer conductor unit 11.

The second boss 15a protrudes toward the feed hole 116 along the outer peripheral side surface of the second conductor column 121a opposite to the feed hole 116 of the outer conductor unit 11, where the protrusion direction is perpendicular to the axial direction of the outer conductor unit 11; and a spacing exists between the second boss 15a and the feed hole 116. In this embodiment, the second boss 15a and the second conductor column 121a may be integrally fitted, or may be in ohmic contact. Optionally, the shape of the second boss 15a includes a cylinder or a cuboid.

A second insertion hole 14a for inserting the microwave feed unit 2 is provided on the end surface of the second boss 15a corresponding to the second feed hole 116a. The second insertion hole 14a is a blind hole, which is a straight cylindrical channel, and extends toward the inside of the second boss 15a along the end surface of the second boss 15a opposite to the feed hole 116. The bottom of the second insertion hole 14a is located in the second boss 15a.

For the second conductor disk 122a and the second probe apparatus 123a, refer to the conductor disk 122 and the probe apparatus 123 in Embodiment 1. The second conductor disk 122a and the second probe apparatus 123a respectively have the same shape, connection position, connection relationship, and function as the conductor disk 122 and the probe apparatus 123 in Embodiment 1, and details are not described herein again.

As shown in FIG. 5 to FIG. 7, the second microwave feed unit 2a may be a coaxial connector in this embodiment, is inserted from the feed hole 116 located on the peripheral side of the outer conductor unit 11, and is mounted on the outer conductor unit 11. The second microwave feed unit 2a includes a second outer conductor 21a, a second inner conductor 22a arranged in the second outer conductor 21a, and a second dielectric layer 23a between the second inner conductor 22a and the second outer conductor 21a.

In this embodiment, the second outer conductor 21a has a straight cylindrical structure with an opening structure at two ends; and when the second microwave feed unit 2a is mounted on the outer conductor unit 11, the side wall of the second outer conductor 21a is in ohmic contact with the inner wall surface of the feed hole 116 located on the outer conductor unit 11.

The second inner conductor 22a is a straight-line, needle-like structure, one end of the second inner conductor 22a is the connecting end 221 and located in the second outer conductor 21a; and the other end is the feed end 222 and located outside the second outer conductor 21a. The connecting end 221 is configured to be connected to the microwave-generating device. The feed end 222 is relatively close to the second inner conductor unit 12a when the second microwave feed unit 2a is mounted on the outer conductor unit 11, and is configured to be inserted into the second insertion hole 14a of the second boss 15a, to implement electric coupling or magnetic coupling, to guide the microwaves to the second microwave feed unit 2a.

Referring to FIG. 6, the second inner conductor 22a is completely inserted into the second insertion hole 14a, and forms good ohmic contact with the second boss 15a, to successfully feed the microwaves. Referring to FIG. 7, the second inner conductor 22a is not completely inserted into the second insertion hole 14a, the first gap 241 exists between the feed end of the second inner conductor 22a and the bottom of the second insertion hole 14a, but can also well feed the microwaves.

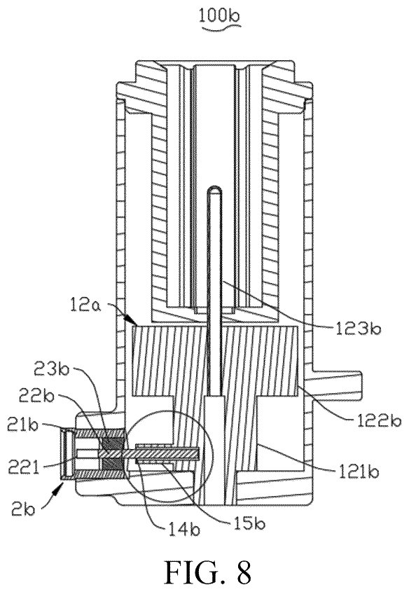

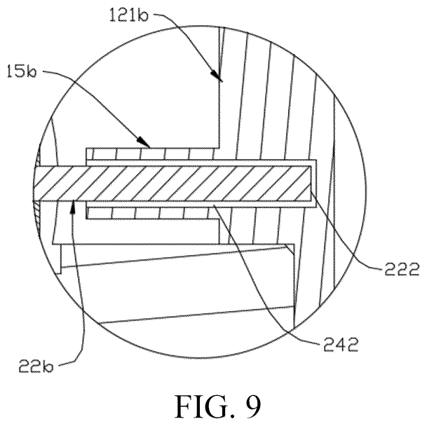

FIG. 8 and FIG. 9 show a third microwave heating assembly 100b according to Embodiment 3 of the present invention. A difference between this embodiment and Embodiment 1 lies in: The inner conductor unit 12 and the microwave feed unit 2 are respectively replaced with a third inner conductor unit 12b and a third microwave feed unit 2b.

As shown in FIG. 8, in this embodiment, the third inner conductor unit 12b includes a third conductor column 121b, a third conductor disk 122b located above the third conductor column 121b, a third boss 15b arranged on the outer peripheral side surface of the third conductor column 121b, and a third probe apparatus 123b embedded in the third conductor disk 122b.

The third conductor column 121b is in the shape of a circular column, the end (namely, the bottom end) of the conductor column 121b away from the open end 112 of the outer conductor unit 11 is coaxially connected to the conductor end wall 115 of the outer conductor unit 11, and the end (namely, the top end) of the conductor column 121b close to the open end 112 extends toward the open end 112 of the outer conductor unit 11. The diameter of the third conductor column 121b is less than the inner diameter of the outer conductor unit 11.

The third boss 15b is formed protruding toward the feed hole 116 along the outer peripheral side surface of the third conductor column 121b opposite to the feed hole 116 of the outer conductor unit 11, but is spaced apart from the feed hole 116. The third boss 15b and the third conductor column 121b may be integrally fitted, or may be in ohmic contact.

A third insertion hole 14b for inserting the microwave feed unit 2 is provided on the end surface of the third boss 15b opposite to the feed hole 116. The third insertion hole 14b is a blind hole, which is a straight cylindrical channel, and extends toward the inside of the third conductor column 121b along the end surface of the third boss 15b corresponding to the feed hole 116. The bottom of the third insertion hole 14b is located in the third conductor column 121b.

In this embodiment, the length of the third insertion hole 14b is greater than the length of the insertion hole 14 in Embodiment 1 and the length of the second insertion hole 14a in Embodiment 2. It may be understood that, by increasing the depth by which the inner conductor 22 of the microwave feed unit 2 is inserted into the third inner conductor unit 12b, reliability of effectively feeding to the third inner conductor unit 12b by the microwave feed unit 2 can be further improved.

For the third conductor disk 122b and the third probe apparatus 123b, refer to the conductor disk 122 and the probe apparatus 123 in Embodiment 1. Third conductor disk 122b and the third probe apparatus 123b respectively have the same shape, connection position, connection relationship, and function as the conductor disk 122 and the probe apparatus 123 in Embodiment 1, and details are not described herein again.

As shown in FIG. 8 to FIG. 9, the third microwave feed unit 2b may be a coaxial connector in this embodiment, is inserted from the feed hole 116 located on the peripheral side of the outer conductor unit 11, and is mounted on the outer conductor unit 11. The third microwave feed unit 2b includes a third outer conductor 21b, a third inner conductor 22b arranged in the third outer conductor 21b, and a third dielectric layer 23b between the third inner conductor 22a and the third outer conductor 21b.

In this embodiment, the third outer conductor 21b has a straight cylindrical structure with an opening structure at two ends; and when the third microwave feed unit 2b is mounted on the outer conductor unit 11, the side wall of the third outer conductor 21b is in ohmic contact with the inner wall surface of the feed hole 116 located on the outer conductor unit 11.

The third inner conductor 22b is a straight-line, needle-like structure, one end of the third inner conductor 22b is the connecting end 221 and located in the third outer conductor 21b; and the other end is the feed end 222 and located outside the third outer conductor 21b. The connecting end 221 is configured to be connected to the microwave-generating device. The feed end 222 is relatively close to the third inner conductor unit 12b when the third microwave feed unit 2b is mounted on the outer conductor unit 11, and is configured to be inserted into the third insertion hole 14b of the third boss 15b, to implement electric coupling or magnetic coupling, to guide the microwaves to the third microwave feed unit 2b.

Referring to FIG. 9, although the third inner conductor 22b extends into the third insertion hole 14b, the first gap 241 and the second gap 242 exist between the third inner conductor 22b and the third insertion hole 14b. However, the microwaves can also be well fed.

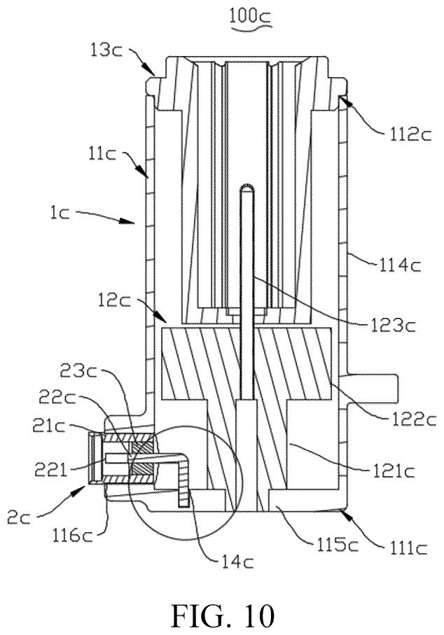

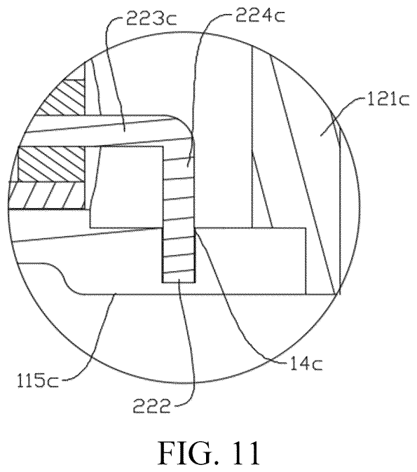

FIG. 10 and FIG. 11 show a fourth microwave heating assembly 100c according to Embodiment 4 of the present invention. A difference between this embodiment and Embodiment 1 lies in: The microwave heating assembly 100 and the microwave feed unit 2 are respectively replaced with a fourth microwave heating assembly 100c and a fourth microwave feed unit 2c.

As shown in FIG. 10, the fourth microwave heating assembly 100c is approximately in the shape of a circular column in appearance, and may include a fourth outer conductor unit 11c, a fourth inner conductor unit 12c, and a fourth accommodating base 13c. The fourth outer conductor unit 11c is configured in a cylindrical shape, includes a fourth closed end 111c and a fourth open end 112c opposite to the fourth closed end 111c, and can define a semi-closed fourth cavity. The fourth cavity is in the shape of a straight circular column. The fourth inner conductor unit 12c is arranged in the fourth cavity of the fourth outer conductor unit 11c, and the axis of the fourth inner conductor unit 12c coincides with the axis of the fourth outer conductor unit 11c. One end of the fourth inner conductor unit 12c is connected to the fourth closed end 111c of the fourth outer conductor unit 11c and is in ohmic contact with the end wall of the fourth closed end 111c, to form a short-circuit end of the fourth microwave heating assembly 100c; and the other end of the fourth inner conductor unit 12c extends toward the fourth open end 112c of the fourth outer conductor unit 11c and is not in contact with the fourth outer conductor unit 11c, to form an open-circuit end of the fourth microwave heating assembly 100c. The fourth accommodating base 13c is mounted at the fourth open end 112c of the fourth outer conductor unit 11c.

In this embodiment, the fourth outer conductor unit 11c may include a fourth conductor side wall 114c and a fourth conductor end wall 115c that are conductive. The fourth conductor side wall 114c may be cylindrical and includes two ends that are oppositely arranged. The fourth conductor end wall 115c is closed at a first end of the fourth conductor side wall 114c, to form the fourth closed end 111c. A second end of the fourth conductor side wall 114c has an open structure, to form the fourth open end 112c, for the fourth accommodating base 13c to be mounted therein. In addition, a fourth feed hole 116c radially running through is provided at a position close to the fourth conductor end wall 115c of the fourth conductor side wall 114c. The fourth feed hole 116c may be used for inserting the fourth microwave feed unit 2c into the fourth outer conductor unit 11c. The hole size of the fourth feed hole 116c matches the outer diameter of the fourth outer conductor 21c of the fourth microwave feed unit 2c.

A fourth insertion hole 14c for inserting the fourth microwave feed unit 2c is further provided on the fourth conductor end wall 115c. The fourth insertion hole 14c is a blind hole, and is recessed along the fourth conductor end wall 115c to be formed. The recessed direction of the fourth insertion hole 14c is parallel to the axial direction of the fourth outer conductor unit 11c. An opening of the fourth insertion hole 14c is opposite to the fourth open end 112c of the fourth outer conductor unit 11c.

As shown in FIG. 10 and FIG. 11, in this embodiment, the fourth inner conductor unit 12c includes a fourth conductor column 121c, a fourth conductor disk 122c located above the fourth conductor column 121c, and a fourth probe apparatus 123c embedded in the fourth conductor disk 122c.

The fourth conductor column 121c is in the shape of a circular column, the end (namely, the bottom end) of the fourth conductor column 121c away from the fourth open end 112c of the fourth outer conductor unit 11c is coaxially connected to the fourth conductor end wall 115c of the fourth outer conductor unit 11c, and the end (namely, the top end) of the fourth conductor column 121c close to the fourth open end 112c extends toward the fourth open end 112c of the fourth outer conductor unit 11c. The diameter of the fourth conductor column 121c is less than the inner diameter of the fourth outer conductor unit 11c.

The fourth conductor disk 122c in the shape of a disk, the diameter of the fourth conductor disk 122c is greater than the diameter of the fourth conductor column 121c, and is arranged on the top end of the fourth conductor column 121c. The fourth conductor disk 122c may be integrally fitted to the fourth conductor column 121c, or may be in ohmic contact with the fourth conductor column 121c.

The fourth probe apparatus 123c may include a longitudinal fourth probe; the lower end of the fourth probe is inserted from the top end of the fourth conductor column 121c, and is coaxially embedded in the fourth conductor disk 122c, to form good ohmic contact with the fourth conductor disk 122c; and the upper end of the fourth probe extends upward into the fourth accommodating base 13c.

As shown in FIG. 10, for the fourth accommodating base 13c, refer to the accommodating base 13 in Embodiment 1. The fourth accommodating base 13c has the same shape, connection position, connection relationship, and function as the accommodating base 13 in Embodiment 1, and details are not described herein again.

As shown in FIG. 10 and FIG. 11, the fourth microwave feed unit 2c may be a coaxial connector in this embodiment, is inserted from the fourth feed hole 116c located on the peripheral side of the fourth outer conductor unit 11c, and is mounted on the fourth outer conductor unit 11c. The fourth microwave feed unit 2c includes a fourth outer conductor 21c, a fourth inner conductor 22c arranged in the fourth outer conductor 21c, and a fourth dielectric layer 23c between the fourth inner conductor 22a and the fourth outer conductor 21c.

In this embodiment, the fourth outer conductor 21c has a straight cylindrical structure with an opening structure at two ends; and when the fourth microwave feed unit 2c is mounted on the fourth outer conductor unit 11c, the side wall of the fourth outer conductor 21c is in ohmic contact with the inner wall surface of the fourth feed hole 116c located on the fourth outer conductor unit 11c.

The fourth inner conductor 22c has an L-shaped, needle-like structure, and includes a first segment 223c perpendicular to the axis of the fourth outer conductor unit 11c and a second segment 224c parallel to the axis of the fourth outer conductor unit 11c. The end portion of the first segment 223c away from the second segment 224c is the connecting end 221, and is configured to be connected to the microwave-generating device, to receive the microwaves. The end portion of the second segment 224c away from the first segment 223c is the feed end 222, and is configured to be inserted into the fourth insertion hole 14c on the fourth conductor end wall 115c to implement electrical coupling or magnetic coupling, to guide the microwaves to the fourth inner conductor unit 12c.

Referring to FIG. 11, the fourth inner conductor 22c is completely inserted into the fourth insertion hole 14c, and forms good ohmic contact with the fourth outer conductor unit 11c, to successfully feed the microwaves.

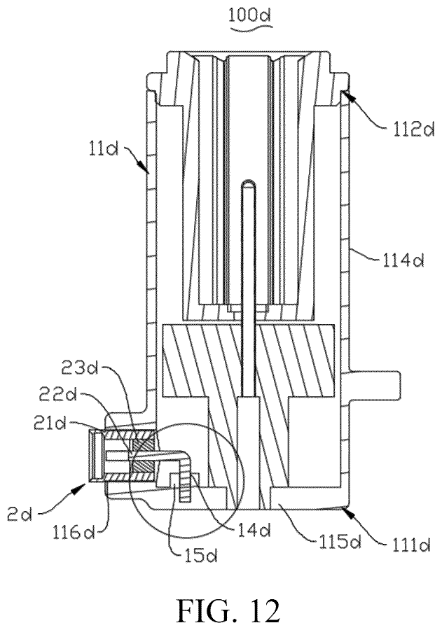

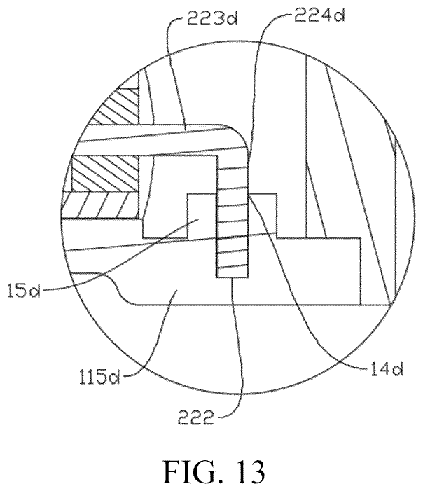

FIG. 12 and FIG. 13 show a fifth microwave heating assembly 100d according to Embodiment 5 of the present invention. A difference between this embodiment and Embodiment 4 lies in: The fourth outer conductor unit 11c and the fourth microwave feed unit 2c are respectively replaced with a fifth outer conductor unit 11d and a fifth microwave feed unit 2d.

As shown in FIG. 12, the fifth outer conductor unit 11d is configured in a cylindrical shape, includes a fifth closed end 111d and a fifth open end 112d opposite to the fifth closed end 111d, and can define a semi-closed fifth cavity. The fifth cavity is in the shape of a straight circular column.

In this embodiment, the fifth outer conductor unit 11d may include a fifth conductor side wall 114d and a fifth conductor end wall 115d that are conductive. The fifth conductor side wall 114d may be cylindrical and includes two ends that are oppositely arranged. The fifth conductor end wall 115d is closed at a first end of the fifth conductor side wall 114d, to form the fifth closed end 111d. A second end of the fifth conductor side wall 114d has an open structure, to form the fifth open end 112d. In addition, a fifth feed hole 116d radially running through is provided at a position close to the fifth conductor end wall 115d of the fifth conductor side wall 114d. The fifth feed hole 116d may be used for inserting the fifth microwave feed unit 2d into the fifth outer conductor unit 11d. The hole size of the fifth feed hole 116d matches the outer diameter of the fifth outer conductor 21d of the fifth microwave feed unit 2d.

A fifth boss 15d protruding in the direction of the fifth open end 112d is further arranged on the fifth conductor end wall 115d, and the protrusion direction of the fifth boss 15d is parallel to the axial direction of the fifth outer conductor unit 11d. A fifth insertion hole 14d for inserting the fifth microwave feed unit 2d is provided on the top of the fifth boss 15d. The fifth insertion hole 14d is a blind hole, and is recessed along the top wall of the fifth boss 15d to be formed. An opening of the fifth insertion hole 14d is opposite to the fifth open end 112d of the fifth outer conductor unit 11d.

As shown in FIG. 12 and FIG. 13, the fifth microwave feed unit 2d may be a coaxial connector in this embodiment, is inserted from the fifth feed hole 116d located on the peripheral side of the fifth outer conductor unit 11d, and is mounted on the fifth outer conductor unit 11d. The fifth microwave feed unit 2d includes a fifth outer conductor 21d, a fifth inner conductor 22d arranged in the fifth outer conductor 21d, and a fifth dielectric layer 23d between the fifth inner conductor 22a and the fifth outer conductor 21d.

In this embodiment, the fifth outer conductor 21d has a straight cylindrical structure with an opening structure at two ends; and when the fifth microwave feed unit 2d is mounted on the fifth outer conductor unit 11d, the side wall of the fifth outer conductor 21d is in ohmic contact with the inner wall surface of the fifth feed hole 116d located on the fifth outer conductor unit 11d.

The fifth inner conductor 22d has an L-shaped, needle-like structure, and includes a first segment 223d perpendicular to the axis of the fifth outer conductor unit 11d and a second segment 224d parallel to the axis of the fifth outer conductor unit 11d. The end portion of the first segment 223d away from the second segment 224d is the connecting end 221, and is configured to be connected to the microwave-generating device, to receive the microwaves. The end portion of the second segment 224d away from the first segment 223d is the feed end 222, configured to be inserted into the fifth insertion hole 14 on the fifth boss 15 to implement electrical coupling or magnetic coupling, to guide the microwaves to the fifth inner conductor unit 12.

Referring to FIG. 13, the fifth inner conductor 22d is completely inserted into the fifth insertion hole 14d, and forms good ohmic contact with the fifth boss 15d, to successfully feed the microwaves.

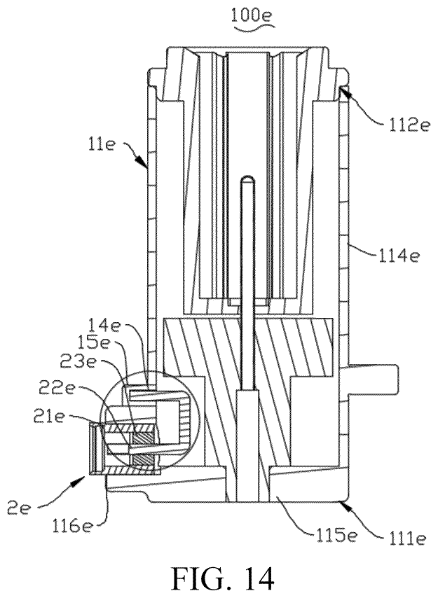

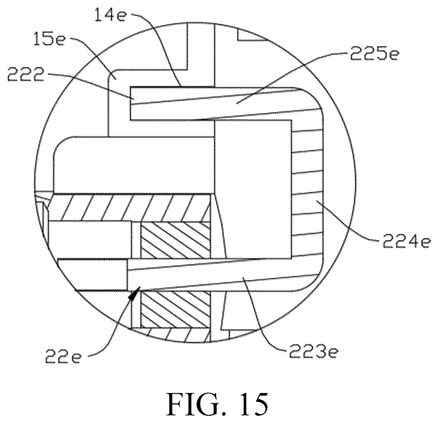

FIG. 14 and FIG. 15 show a sixth microwave heating assembly 100e according to Embodiment 6 of the present invention. A difference between this embodiment and Embodiment 4 lies in: The fourth outer conductor unit 11c and the fourth microwave feed unit 2c are respectively replaced with a sixth outer conductor unit 11e and a sixth microwave feed unit 2e.

As shown in FIG. 14, the sixth outer conductor unit 11e is configured in a cylindrical shape, includes a sixth closed end 111e and a sixth open end 112e opposite to the sixth closed end 111e, and can define a semi-closed sixth cavity. The sixth cavity is in the shape of a straight circular column.

In this embodiment, the sixth outer conductor unit 11e may include a sixth conductor side wall 114e and a sixth conductor end wall 115e that are conductive. The sixth conductor side wall 114e may be cylindrical and includes two ends that are oppositely arranged. The sixth conductor end wall 115e is closed at a first end of the sixth conductor side wall 114e, to form the sixth closed end 111e. A second end of the sixth conductor side wall 114e has an open structure, to form the sixth open end 112e. In addition, a sixth feed hole 116e radially running through is provided at a position close to the sixth conductor end wall 115e of the sixth conductor side wall 114e. The sixth feed hole 116e may be used for inserting the sixth microwave feed unit 2e into the sixth outer conductor unit 11e. The hole size of the sixth feed hole 116e matches the outer diameter of the sixth outer conductor 21e of the sixth microwave feed unit 2e.

As shown in FIG. 14 and FIG. 15, a sixth boss 15e protruding outward is arranged at a peripheral position of the sixth feed hole 116e (for example, above the sixth feed hole 116) on the sixth conductor side wall 114e, and a sixth insertion hole 14e for inserting the sixth microwave feed unit 2e is further provided on the sixth conductor side wall 114e. The sixth insertion hole 14e is a blind hole, runs through the sixth conductor side wall 114e, and extends toward the sixth boss 15e. The bottom of the sixth insertion hole 14e extends into the sixth boss 15e. A direction in which the sixth insertion hole 14e extends is perpendicular to the axial direction of the sixth outer conductor unit 11e.

As shown in FIG. 14 and FIG. 15, the sixth microwave feed unit 2e may be a coaxial connector in this embodiment, is inserted from the sixth feed hole 116e located on the peripheral side of the sixth outer conductor unit 11e, and is mounted on the sixth outer conductor unit 11e. The sixth microwave feed unit 2e includes a sixth outer conductor 21e, a sixth inner conductor 22e arranged in the sixth outer conductor 21e, and a sixth dielectric layer 23e between the sixth inner conductor 22a and the sixth outer conductor 21e.

In this embodiment, the sixth outer conductor 21e has a straight cylindrical structure with an opening structure at two ends; and when the sixth microwave feed unit 2e is mounted on the sixth outer conductor unit 11e, the side wall of the sixth outer conductor 21e is in ohmic contact with the inner wall surface of the sixth feed hole 116e located on the sixth outer conductor unit 11e.

The sixth inner conductor 22e approximately has a U-shaped, needle-like structure, and includes a first segment 223e perpendicular to the axis of the sixth outer conductor unit 11e, a second segment 224e parallel to the axis of the sixth outer conductor unit 11e, and a third segment 225e parallel to the first segment 223e. A partial structure of the first segment 223e is arranged in the sixth outer conductor 21e, and the end portion of the first segment 223e away from the second segment 224e is the connecting end 221, and is configured to be connected to the microwave-generating device, to receive the microwaves. The third segment 225e is located outside the sixth outer conductor 21e, and when the sixth microwave feed unit 2e is mounted on the sixth outer conductor unit 11e, the third segment 225e extends into the sixth outer conductor unit 11e. The end portion of the third segment 225e away from the first segment 223e is the feed end 222, and is configured to be inserted into the sixth insertion hole 14e located on the sixth conductor side wall 114e of the sixth outer conductor unit 11e to implement electric coupling or magnetic coupling, to feed the microwaves. The second segment 224e is used as a connection part connecting the first segment 223e to the third segment 225e, and is connected to the first segment 223e and the third segment 225e, where a connection manner may be integral connection.

Referring to FIG. 11, the sixth inner conductor 22e is completely inserted into the sixth insertion hole 14e, and forms good ohmic contact with the sixth outer conductor unit 11e, to successfully feed the microwaves.

It should be noted that the sixth boss 15e is used in this embodiment as a preferred solution, and is not a necessary technical feature in this embodiment. When no sixth boss 15e is provided, the sixth insertion hole 14e may be provided on the sixth conductor side wall 114e, and is recessed outward along the inner wall surface of the sixth conductor side wall 114e to be formed. The bottom of the sixth insertion hole 14e is located in the side wall of the sixth conductor side wall 114e.

It may be understood that, in combination with Embodiment 1 to Embodiment 6, in the aerosol-generating device in the present invention, a insertion hole 14 is provided on an inner conductor unit 12 or the inner side of an outer conductor unit 11, where a specific position of the insertion hole 14 may be on a conductor column 121, a conductor end wall 115 of the outer conductor unit 11, or a conductor side wall 114 of the outer conductor unit 11, or may be on a boss (15a, 15b, or 15d) on the conductor column 121 or the conductor end wall 115 of the outer conductor unit 11. Therefore, when the microwave feed unit 2 is mounted on the outer conductor unit 11, and the inner conductor 22 of the microwave feed unit 2 is inserted into the insertion hole 14, even if the inner conductor 22 is not in contact with the insertion hole 14, the characteristic of capacitive transmission of microwaves can be used, thereby implementing good microwave feeding, and improving reliability of microwave feeding. In addition, arrangement of the boss (15a, 15b, or 15d) can increase the depth of the insertion hole 14, to further enhance reliability of microwave feeding.

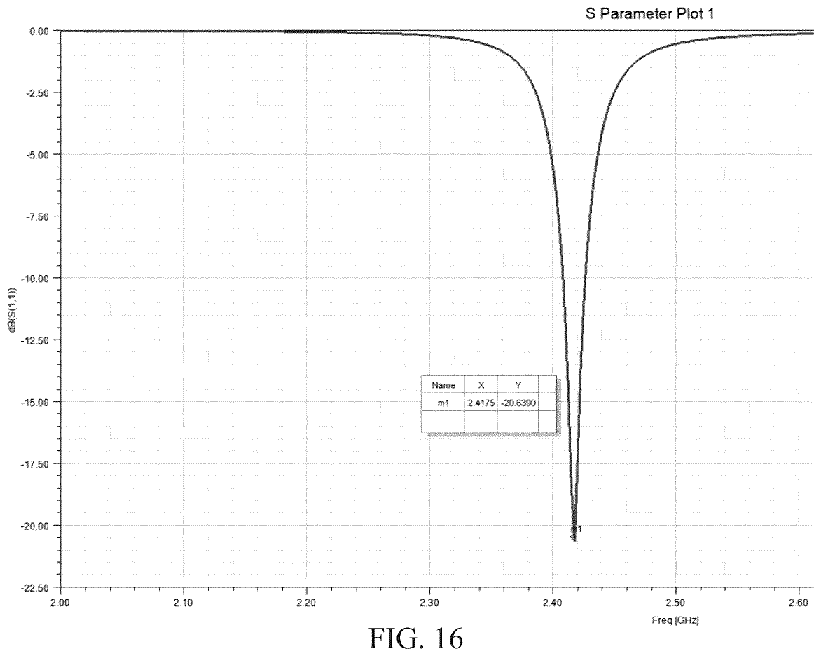

The following experimental data, with reference to FIG. 16 to FIG. 29, specifically demonstrates the function of the insertion hole 14 in the aerosol-generating device.

In Experiment 1, a test was performed by using the microwave heating assembly 100 in Embodiment 1. In the experiment, the diameter of the inner conductor 22 was 0.7 mm, the diameter of the insertion hole 14 was 0.76 mm, the depth by which the inner conductor 22 was inserted into the insertion hole 14 was 2.5 mm, the second gap 242 of 0.03 mm existed between the outer peripheral side surface of the inner conductor 22 and the inner peripheral wall surface of the insertion hole 14, and the first gap 241 of 0.01 mm existed between the feed end 222 of the inner conductor 22 and the bottom of the insertion hole 14. FIG. 16 is a scattering parameter diagram obtained by testing in Experiment 1 based on the microwave heating assembly 100 according to Embodiment 1. It can be seen from FIG. 16 that, even if the inner conductor 22 cannot be in good contact with the insertion hole 14, a scattering parameter S11 can reach −20.6390 dB.

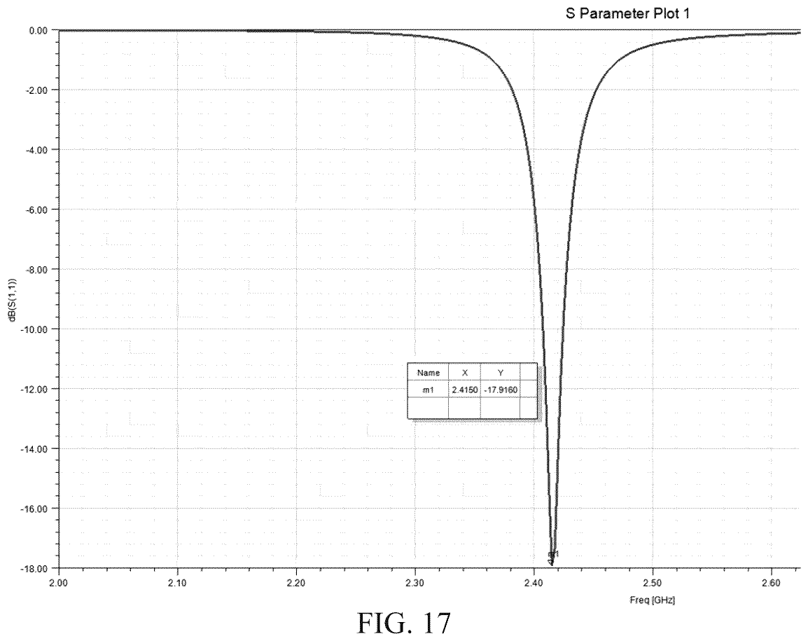

In Experiment 2, a test was still performed by using the microwave heating assembly 100 in Embodiment 1. In the experiment, the diameter of the inner conductor 22 was 0.7 mm, the diameter of the insertion hole 14 was 0.76 mm, the depth by which the inner conductor 22 was inserted into the insertion hole 14 was 2.5 mm, the second gap 242 of 0.03 mm existed between the outer peripheral side surface of the inner conductor 22 and the inner peripheral wall surface of the insertion hole 14, and the first gap 241 of 0.05 mm existed between the feed end 222 of the inner conductor 22 and the bottom of the insertion hole 14. FIG. 17 is a scattering parameter diagram obtained by testing in Experiment 2 based on the microwave heating assembly 100 according to Embodiment 1. It can be seen from FIG. 17 that, in the microwave heating assembly 100 in Embodiment 1, even if the inner conductor 22 of the microwave heating assembly 100 cannot be in good contact with the insertion hole 14, the scattering parameter S11 reaches −17.9160 dB.

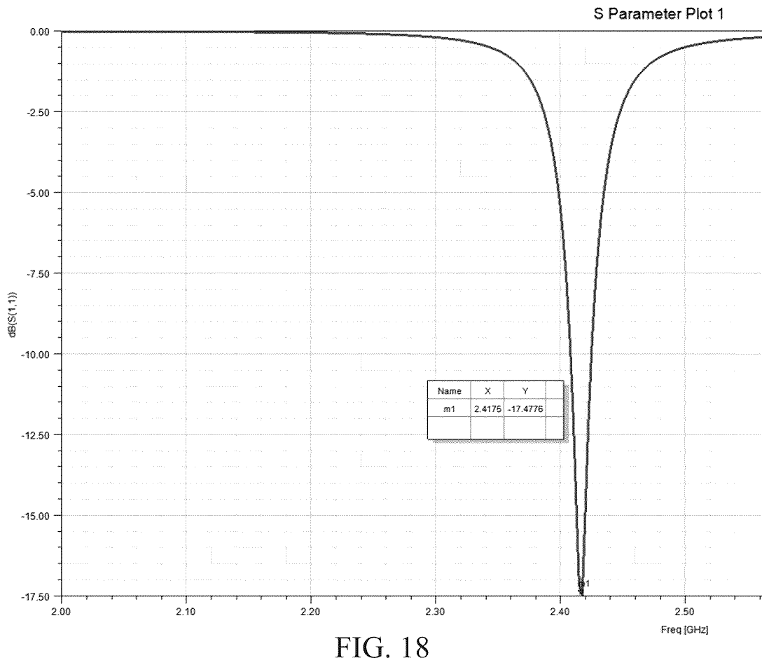

In Experiment 3, a test was still performed by using the microwave heating assembly 100 in Embodiment 1. In the experiment, the diameter of the inner conductor 22 was 0.7 mm, the diameter of the insertion hole 14 was 0.76 mm, the depth by which the inner conductor 22 was inserted into the insertion hole 14 was 2.5 mm, the second gap 242 of 0.03 mm existed between the outer peripheral side surface of the inner conductor 22 and the inner peripheral wall surface of the insertion hole 14, and the first gap 241 of 0.1 mm existed between the feed end 222 of the inner conductor 22 and the bottom of the insertion hole 14. FIG. 18 is a scattering parameter diagram obtained by testing in Experiment 3 based on the microwave heating assembly 100 according to Embodiment 1. It can be seen from FIG. 18 that, in the microwave heating assembly 100 in Embodiment 1, even if the inner conductor 22 of the microwave heating assembly 100 cannot be in good contact with the insertion hole 14, the scattering parameter S11 reaches −17.4776 dB.

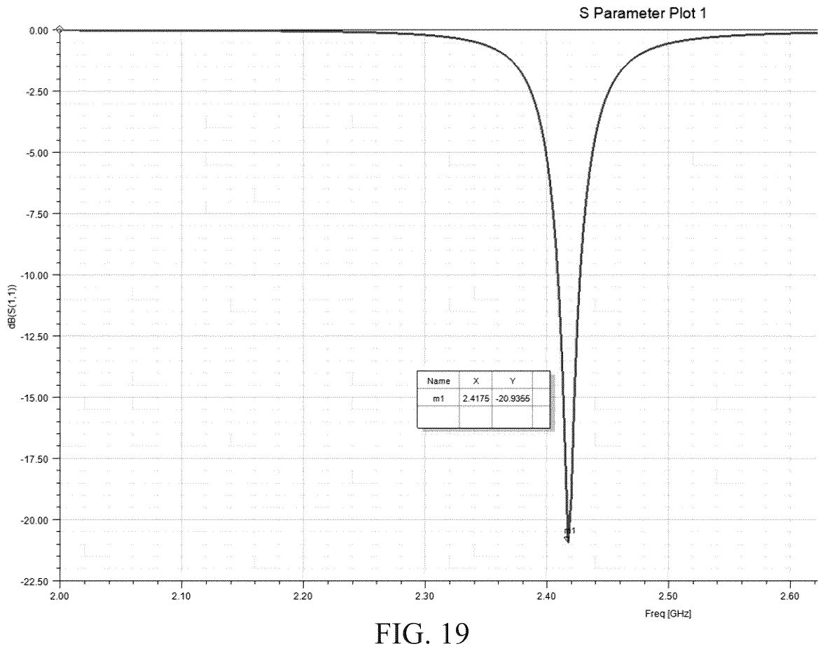

In Experiment 4, a test was still performed by using the microwave heating assembly 100 in Embodiment 1. In the experiment, the diameter of the inner conductor 22 was 0.7 mm, the diameter of the insertion hole 14 was 0.75 mm, the depth by which the inner conductor 22 was inserted into the insertion hole 14 was 2.5 mm, the second gap 242 of 0.025 mm existed between the outer peripheral side surface of the inner conductor 22 and the inner peripheral wall surface of the insertion hole 14, and the first gap 241 of 0.05 mm existed between the feed end 222 of the inner conductor 22 and the bottom of the insertion hole 14. FIG. 19 is a scattering parameter diagram obtained by testing in Experiment 4 based on the microwave heating assembly 100 according to Embodiment 1. It can be seen from FIG. 19 that, in the microwave heating assembly 100 in Embodiment 1, even if the inner conductor 22 of the microwave heating assembly 100 cannot be in good contact with the insertion hole 14, the scattering parameter S11 reaches −20.9355 dB.

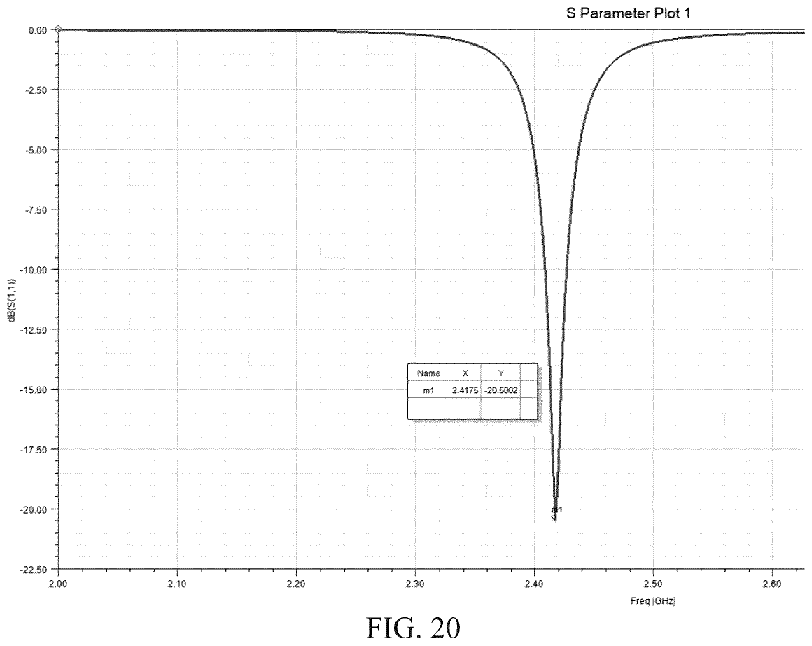

In Experiment 5, a test was still performed by using the microwave heating assembly 100 in Embodiment 1. In the experiment, the diameter of the inner conductor 22 was 0.7 mm, the diameter of the insertion hole 14 was 0.75 mm, the depth by which the inner conductor 22 was inserted into the insertion hole 14 was 2.5 mm, the second gap 242 of 0.03 mm existed between the outer peripheral side surface of the inner conductor 22 and the inner peripheral wall surface of the insertion hole 14, and the first gap 241 of 0.1 mm existed between the feed end 222 of the inner conductor 22 and the bottom of the insertion hole 14. FIG. 20 is a scattering parameter diagram obtained by testing in Experiment 5 based on the microwave heating assembly 100 according to Embodiment 1. It can be seen from FIG. 20 that, in the microwave heating assembly 100 in Embodiment 1, even if the inner conductor 22 of the microwave heating assembly 100 cannot be in good contact with the insertion hole 14, the scattering parameter S11 reaches −20.5002 dB.

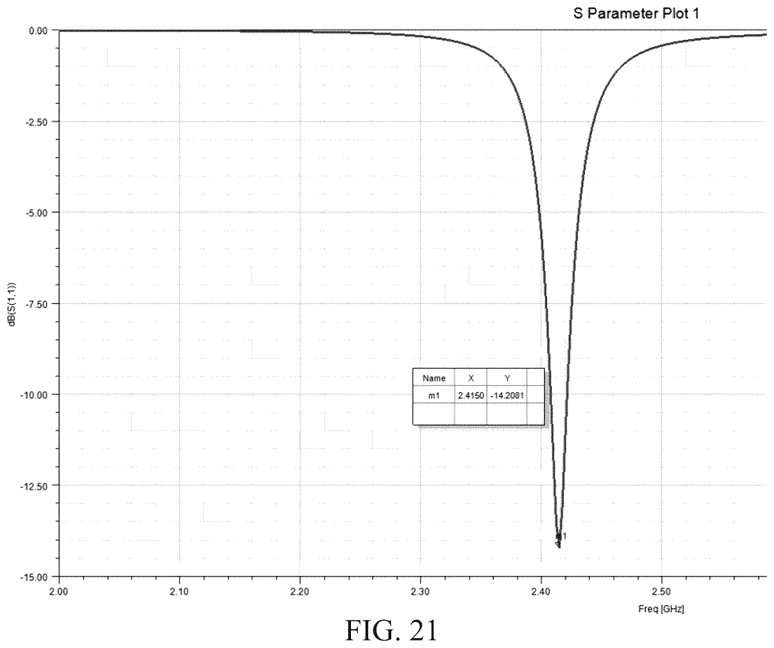

In Experiment 6, a test was still performed by using the microwave heating assembly 100 in Embodiment 1. In the experiment, the diameter of the inner conductor 22 was 0.7 mm, the diameter of the insertion hole 14 was 0.78 mm, the depth by which the inner conductor 22 was inserted into the insertion hole 14 was 2.5 mm, the second gap 242 of 0.04 mm existed between the outer peripheral side surface of the inner conductor 22 and the inner peripheral wall surface of the insertion hole 14, and the first gap 241 of 0.05 mm existed between the feed end 222 of the inner conductor 22 and the bottom of the insertion hole 14. FIG. 21 is a scattering parameter diagram obtained by testing in Experiment 6 based on the microwave heating assembly 100 according to Embodiment 1. It can be seen from FIG. 21 that, in the microwave heating assembly 100 in Embodiment 1, even if the inner conductor 22 of the microwave heating assembly 100 cannot be in good contact with the insertion hole 14, the scattering parameter S11 reaches −14.2081 dB.

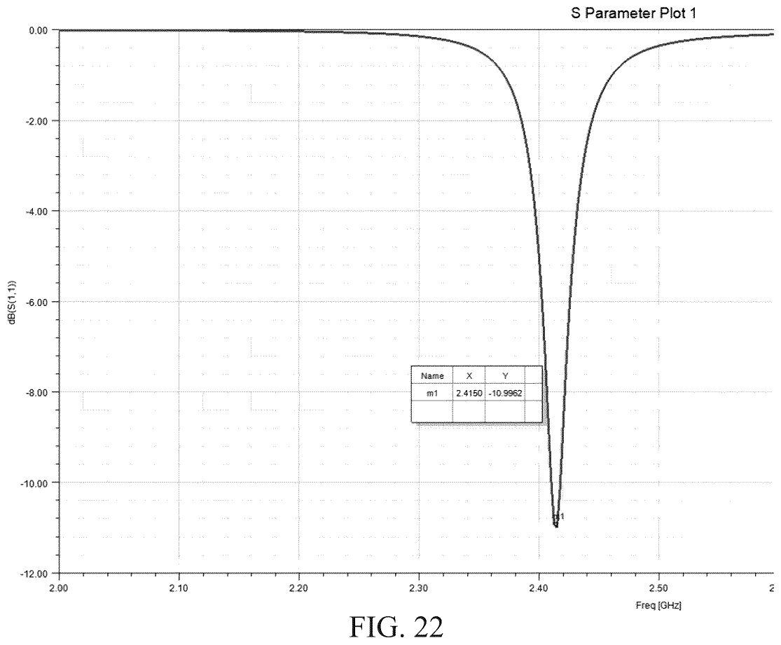

In Experiment 7, a test was still performed by using the microwave heating assembly 100 in Embodiment 1. In the experiment, the diameter of the inner conductor 22 was 0.7 mm, the diameter of the insertion hole 14 was 0.8 mm, the depth by which the inner conductor 22 was inserted into the insertion hole 14 was 2.5 mm, the second gap 242 of 0.05 mm existed between the outer peripheral side surface of the inner conductor 22 and the inner peripheral wall surface of the insertion hole 14, and the first gap 241 of 0.05 mm existed between the feed end 222 of the inner conductor 22 and the bottom of the insertion hole 14. FIG. 22 is a scattering parameter diagram obtained by testing in Experiment 7 based on the microwave heating assembly 100 according to Embodiment 1. It can be seen from FIG. 22 that, in the microwave heating assembly 100 in Embodiment 1, even if the inner conductor 22 of the microwave heating assembly 100 cannot be in good contact with the insertion hole 14, the scattering parameter S11 reaches −10.9962 dB.

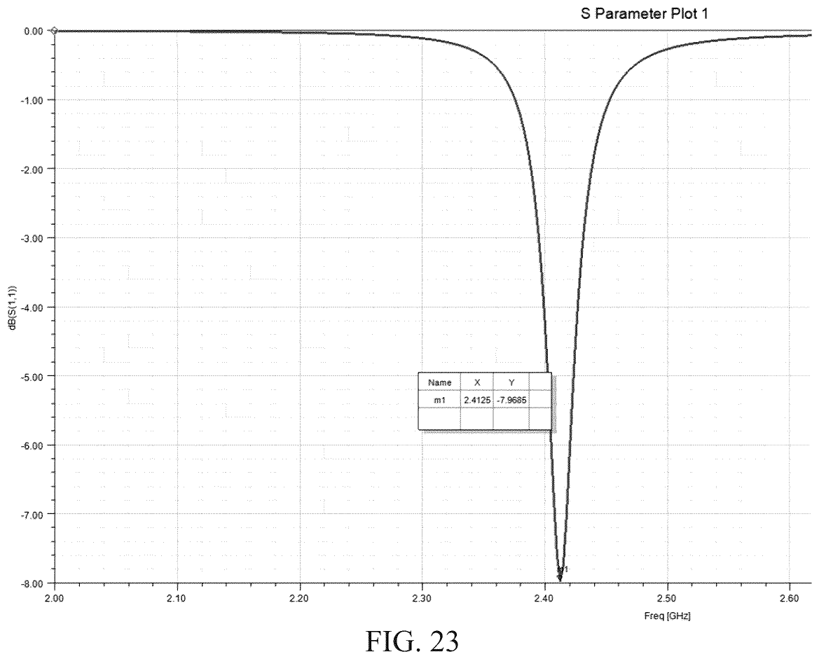

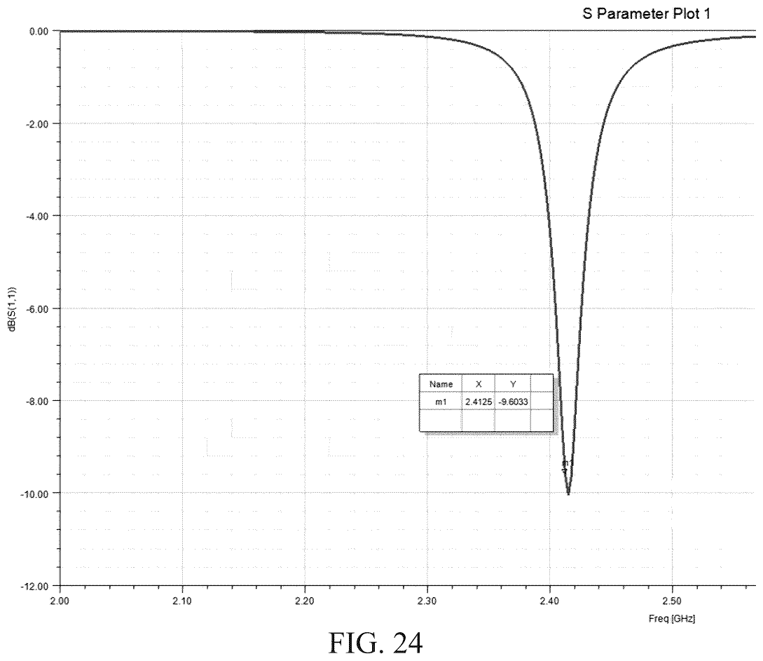

In Experiment 8, a test was still performed by using the microwave heating assembly 100 in Embodiment 1. In the experiment, the diameter of the inner conductor 22 was 0.7 mm, the diameter of the insertion hole 14 was 0.8 mm, the depth by which the inner conductor 22 was inserted into the insertion hole 14 was 1 mm, the second gap 242 of 0.05 mm existed between the outer peripheral side surface of the inner conductor 22 and the inner peripheral wall surface of the insertion hole 14, and the first gap 241 of 0.05 mm existed between the feed end 222 of the inner conductor 22 and the bottom of the insertion hole 14. FIG. 23 is a scattering parameter diagram obtained by testing in Experiment 8 based on the microwave heating assembly 100 according to Embodiment 1. It can be seen from FIG. 23 that, in the microwave heating assembly 100 in Embodiment 1, even if the inner conductor 22 of the microwave heating assembly 100 cannot be in good contact with the insertion hole 14, the scattering parameter S11 reaches −7.9685 dB.

In Experiment 9, a test was still performed by using the microwave heating assembly 100 in Embodiment 1. In the experiment, the diameter of the inner conductor 22 was 0.7 mm, the diameter of the insertion hole 14 was 0.75 mm, the depth by which the inner conductor 22 was inserted into the insertion hole 14 was 1.2 mm, the second gap 242 of 0.025 mm existed between the outer peripheral side surface of the inner conductor 22 and the inner peripheral wall surface of the insertion hole 14, and the first gap 241 of 0.05 mm existed between the feed end 222 of the inner conductor 22 and the bottom of the insertion hole 14. FIG. 24 is a scattering parameter diagram obtained by testing in Experiment 9 based on the microwave heating assembly 100 according to Embodiment 1. It can be seen from FIG. 24 that, in the microwave heating assembly 100 in Embodiment 1, even if the inner conductor 22 of the microwave heating assembly 100 cannot be in good contact with the insertion hole 14, the scattering parameter S11 reaches −9.6033 dB.

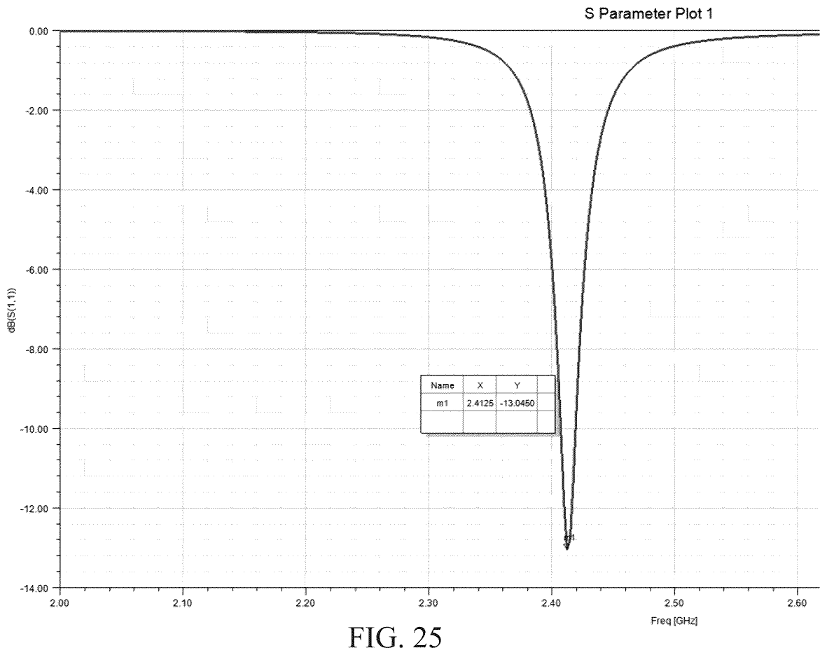

In Experiment 10, a test was still performed by using the microwave heating assembly 100 in Embodiment 1. In the experiment, the diameter of the inner conductor 22 was 0.7 mm, the diameter of the insertion hole 14 was 0.75 mm, the depth by which the inner conductor 22 was inserted into the insertion hole 14 was 1.5 mm, the second gap 242 of 0.025 mm existed between the outer peripheral side surface of the inner conductor 22 and the inner peripheral wall surface of the insertion hole 14, and the first gap 241 of 0.05 mm existed between the feed end 222 of the inner conductor 22 and the bottom of the insertion hole 14. FIG. 25 is a scattering parameter diagram obtained by testing in Experiment 10 based on the microwave heating assembly 100 according to Embodiment 1. It can be seen from FIG. 25 that, in the microwave heating assembly 100 in Embodiment 1, even if the inner conductor 22 of the microwave heating assembly 100 cannot be in good contact with the insertion hole 14, the scattering parameter S11 reaches −13.0450 dB.

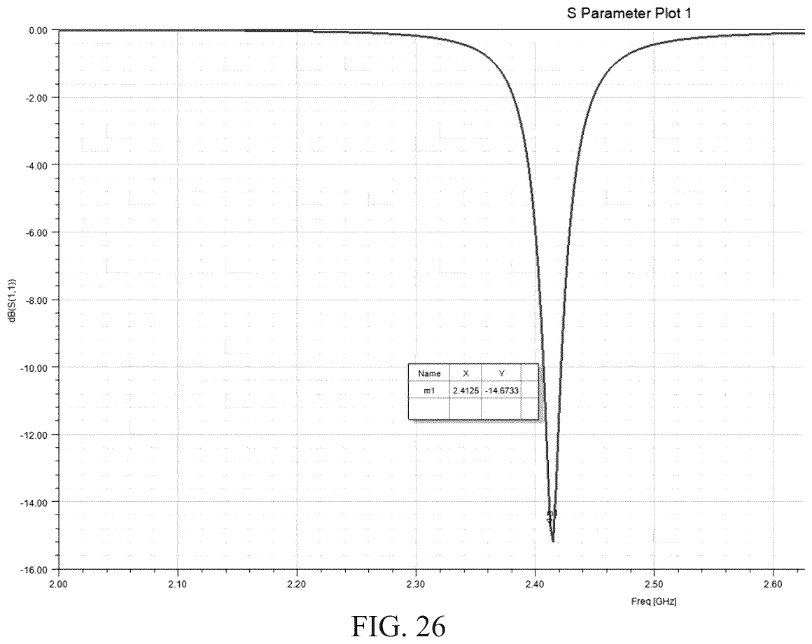

In Experiment 11, a test was still performed by using the microwave heating assembly 100 in Embodiment 1. In the experiment, the diameter of the inner conductor 22 was 0.7 mm, the diameter of the insertion hole 14 was 0.75 mm, the depth by which the inner conductor 22 was inserted into the insertion hole 14 was 1.8 mm, the second gap 242 of 0.025 mm existed between the outer peripheral side surface of the inner conductor 22 and the inner peripheral wall surface of the insertion hole 14, and the first gap 241 of 0.05 mm existed between the feed end 222 of the inner conductor 22 and the bottom of the insertion hole 14. FIG. 26 is a scattering parameter diagram obtained by testing in Experiment 11 based on the microwave heating assembly 100 according to Embodiment 1. It can be seen from FIG. 26 that, in the microwave heating assembly 100 in Embodiment 1, even if the inner conductor 22 of the microwave heating assembly 100 cannot be in good contact with the insertion hole 14, the scattering parameter S11 reaches −14.6733 dB.

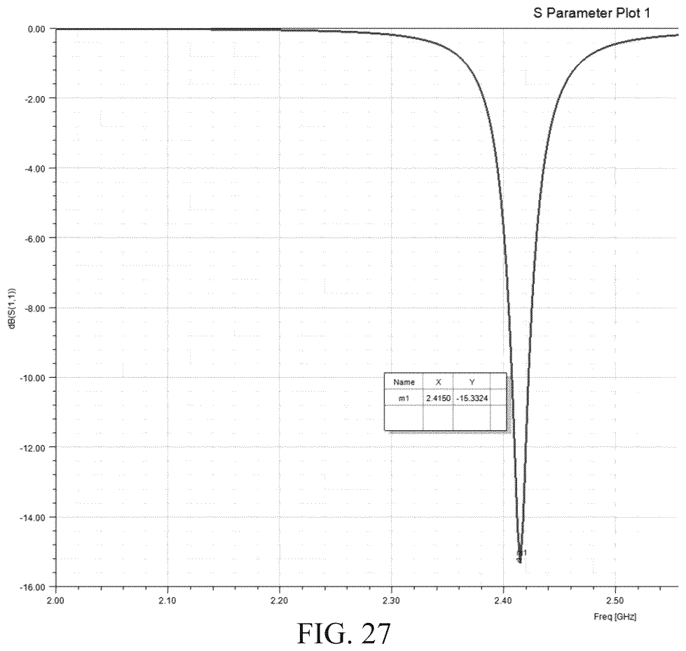

In Experiment 12, a test was still performed by using the microwave heating assembly 100 in Embodiment 1. In the experiment, the diameter of the inner conductor 22 was 0.7 mm, the diameter of the insertion hole 14 was 0.75 mm, the depth by which the inner conductor 22 was inserted into the insertion hole 14 was 1.8 mm, the second gap 242 of 0.025 mm existed between the outer peripheral side surface of the inner conductor 22 and the inner peripheral wall surface of the insertion hole 14, and the first gap 241 of 0.03 mm existed between the feed end 222 of the inner conductor 22 and the bottom of the insertion hole 14. FIG. 27 is a scattering parameter diagram obtained by testing in Experiment 12 based on the microwave heating assembly 100 according to Embodiment 1. It can be seen from FIG. 27 that, in the microwave heating assembly 100 in Embodiment 1, even if the inner conductor 22 of the microwave heating assembly 100 cannot be in good contact with the insertion hole 14, the scattering parameter S11 reaches −15.33 dB.

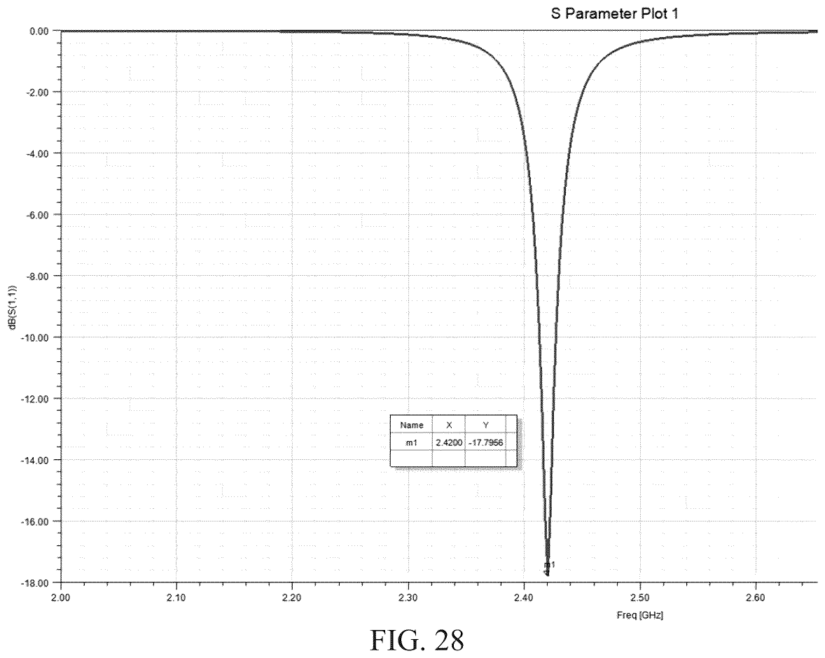

In Experiment 13, a test was performed by using the second microwave heating assembly 100a in Embodiment 2. In the experiment, the diameter of the inner conductor 22 was 0.7 mm, the diameter of the second insertion hole 14a was 0.75 mm, the depth by which the inner conductor 22 was inserted into the second insertion hole 14a was 1.8 mm, the second gap 242 of 0.01 mm existed between the outer peripheral side surface of the inner conductor 22 and the inner peripheral wall surface of the second insertion hole 14a, and the first gap 241 of 0.025 mm existed between the feed end 222 of the inner conductor 22 and the bottom of the second insertion hole 14a. FIG. 28 is a scattering parameter diagram obtained by testing in Experiment 13 based on the second microwave heating assembly 100a according to Embodiment 2. It can be seen from FIG. 28 that, in the second microwave heating assembly 100a in Embodiment 2, even if the inner conductor 22 of the microwave heating assembly 100a cannot be in good contact with the second insertion hole 14a, the scattering parameter S11 reaches −17.7956 dB.

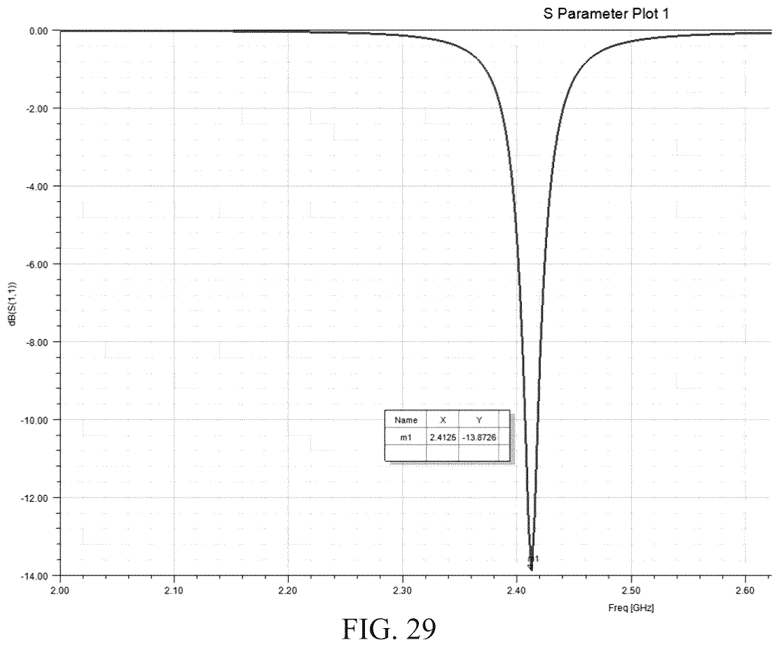

In Experiment 14, a test was performed by using the second microwave heating assembly 100a in Embodiment 2. In the experiment, the diameter of the inner conductor 22 was 0.7 mm, the diameter of the second insertion hole 14a was 0.75 mm, the depth by which the inner conductor 22 was inserted into the second insertion hole 14a was 1.8 mm, the second gap 242 of 0.03 mm existed between the outer peripheral side surface of the inner conductor 22 and the inner peripheral wall surface of the second insertion hole 14a, and the first gap 241 of 0.025 mm existed between the feed end 222 of the inner conductor 22 and the bottom of the second insertion hole 14a. FIG. 29 is a scattering parameter diagram obtained by testing in Experiment 14 based on the second microwave heating assembly 100a according to Embodiment 2. It can be seen from FIG. 29 that, in the second microwave heating assembly 100a in Embodiment 2, even if the inner conductor 22 of the microwave heating assembly 100a cannot be in good contact with the second insertion hole 14a, the scattering parameter S11 reaches −13.8726 dB.

In conclusion, Experiment 1 to Experiment 12 can demonstrate that good microwave feeding can be achieved when the gap between the inner conductor 22 and the insertion hole 14 is within 0.1 mm, and as the gap gradually decreases, an effect of microwave feeding gradually is improved. When the gap between the inner conductor 22 and the insertion hole 14 is within 0.03 mm, the microwaves can still be efficiently fed to the microwave heating assembly 100.

Therefore, the gap between the inner conductor 22 and the insertion hole 14 may be controlled to be within 0.1 mm, preferably, within 0.05 mm, and further, within 0.03 mm. This tolerance range is achievable during a machining process. Therefore, this structure makes actual machining and assembly of the microwave heating assembly 100 feasible, and also greatly improves the reliability of microwave feeding therein. In particular, any material has a specific dimensional deformation as the temperature changes, but in the present invention, the microwaves can still be efficiently fed even after deformation occurs.

Secondly, Experiment 13 and Experiment 14 can demonstrate that by providing the insertion hole 14 on the conductor column 121 or on the boss (15a, 15b, or 15d) on the conductor end wall 115 of the outer conductor unit 11, a feeding effect is similar to the experimental results of Experiment 1 to Experiment 12, and the microwave feed unit 2 can also effectively feed microwaves through capacitive feeding.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A microwave heating assembly for an aerosol-generating device, the microwave heating assembly comprising:
an outer conductor unit in a cylindrical shape and comprising an open end, a closed end opposite the open end, and a cavity located between the open end and the closed end;
an inner conductor unit arranged in the cavity, one end of the inner conductor being connected to an end wall of the closed end, and an other end of the inner conductor unit extending toward the open end; and
a microwave feed unit, comprising:
an outer conductor mounted on the outer conductor unit and in ohmic contact with the outer conductor unit, and
an inner conductor arranged in the outer conductor and comprising a feed end extending into the cavity so as to feed microwaves,
wherein an insertion hole is provided on an inner side of the outer conductor unit or on the inner conductor unit, the feed end extending into the insertion hole.

2. The microwave heating assembly of claim 1, wherein the feed end is in ohmic contact with an inner wall surface of the insertion hole.

3. The microwave heating assembly of claim 1, wherein a first gap exists between an end surface of the feed end and a bottom of the insertion hole, the first gap being less than or equal to 0.1 mm, and
wherein a second gap exists between an outer peripheral wall surface of the feed end and an inner peripheral wall surface of the insertion hole, the second gap being less than or equal to 0.1 mm.

4. The microwave heating assembly of claim 1, wherein the insertion hole is a blind hole.

5. The microwave heating assembly of claim 1, wherein a depth of the insertion hole ranges from 0.9 mm to 2.6 mm.

6. The microwave heating assembly of claim 1, wherein the insertion hole is cylindrical, and
wherein a diameter of the insertion hole ranges from 0.65 mm to 0.9 mm.

7. The microwave heating assembly of claim 1, wherein a feed hole that communicates the cavity with an outside is provided on a side wall of the outer conductor unit, and
wherein the outer conductor is embedded in the feed hole.

8. The microwave heating assembly of claim 7, wherein the inner conductor unit comprises a conductor column, the conductor column comprising a fixed end and a free end, the fixed end being connected to the closed end and in ohmic contact with the end wall of the closed end, the free end extending toward the open end.

9. The microwave heating assembly of claim 8, wherein the insertion hole is provided on the outer peripheral wall of the conductor column and is opposite the feed hole, and
wherein the insertion hole extends in a radial direction of the conductor column.

10. The microwave heating assembly of claim 8, wherein the inner conductor unit comprises a boss fitted to a side wall of the conductor column,
wherein the boss protrudes from the conductor column toward the feed hole, and
wherein the insertion hole is formed in the boss and extends away from the feed hole and along an end surface of the boss facing the feed hole.

11. The microwave heating assembly of claim 10, wherein a bottom of the insertion hole extends into the conductor column.

12. The microwave heating assembly of claim 9, wherein the inner conductor is in a shape of a straight line and extends into the insertion hole in a direction perpendicular to an axis of the conductor column.

13. The microwave heating assembly of claim 1, wherein the insertion hole is formed on an end wall of the closed end.

14. The microwave heating assembly of claim 1, wherein a boss protruding toward the open end is provided on an end wall of the closed end, and
wherein the insertion hole is provided on the boss.

15. The microwave heating assembly of claim 13, wherein the inner conductor is L-shaped and comprises a first segment and a second segment connected to the first segment,
wherein the end of the first segment away from the second segment is configured to receive microwaves, and
wherein an end of the second segment away from the first segment is the feed end.

16. The microwave heating assembly of claim 1, wherein the insertion hole is provided on an inner peripheral side wall of the outer conductor unit.

17. The microwave heating assembly of claim 1, wherein a boss protruding outward is arranged on an outer surface of the outer conductor unit,
wherein the insertion hole runs through a wall surface of the outer conductor unit and extends toward the boss,
wherein an opening of the insertion hole is formed on the inner wall surface of the outer conductor unit, and
wherein a bottom of the insertion hole extends into the boss.

18. The microwave heating assembly of claim 16, wherein the inner conductor is U-shaped and comprises a first segment, a second segment, and a third segment,
wherein the third segment is parallel to the first segment, and two ends of the second segment are respectively connected to the first segment and the third segment, and
wherein an end of the first segment away from the second segment is configured to receive microwaves, and an end of the third segment away from the second segment is the feed end.

19. The microwave heating assembly of claim 1, further comprising:
an accommodating base mounted on the open end, the accommodating base comprising an accommodating portion configured to accommodate an aerosol-generation substrate, the accommodating portion being located in the cavity.

20. An aerosol-generating device, comprising:
a microwave-generating device; and
the microwave heating assembly of claim 1,
wherein the microwave feed unit is connected to the microwave-generating device.
